(19) United States
(12) Patent Application Publication
(10) Pub. No.: US 2010/0262684 A1
(43) Pub. Date: Oct. 14, 2010

(54) METHOD AND DEVICE FOR PACKET CLASSIFICATION

(75) Inventors: Denis Valois, Mouans-Sartoux (FR); Cédric Llorens, Le Chesnay (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/741,860

(22) PCT Filed: Nov. 13, 2008
(86) PCT No.: PCT/FR08/52046

§ 371 Date: May 7, 2010

(30) Foreign Application Priority Data
Nov. 16, 2007 (FR) 07 59124

(51) Int. Cl. H04L 29/06

(52) U.S. Cl. 709/223

(57) ABSTRACT

A method for classification data packets by means of an ordered access control list (L) of at least one classification rule (Rₖ), comprising a step for determining, for each data packet to be classified, a value (e) used to identify a category of packet, a data packet comprising a set of one or more data fields according to the values of which the classification value assigned to this packet is determined, a said classification rule (Rₖ) defining, on the one hand, a classification criterion relating to at least one said data field and, on the other, a classification value intended to be assigned a packet for which said at least one said data field has a value matching said classification criterion, wherein the classification value determined for a packet is obtained in a number NB of iterations (310) starting from an initial classification value (e₀) by processing, in a predetermined order, a set of NB data blocks including the set of data fields from the packet in question, the size of said data blocks being chosen from amongst a set of several possible values.

The invention relates to the field of telecommunications networks and, in particular, to a packet classification method and a device. The term “classification” is used in this document in its wider sense: the classification of a set of packets corresponds to the dividing up a set of packets into several groups or categories. The act of classification does not imply any ordering.

Certain types of telecommunication network equipment, incorporating modules of the router or firewall type, implement network access functions by means of an ordered list of rules, known as ACL (access control list) or list for access control according to the Anglo-Saxon terminology. Each of the rules of such a list comprises a description of the frames—called template—, in terms of possible values for the header fields of this frame, and an associated processing operation, for example “pass” or “reject”. Thus, when a frame reaches the equipment, the values contained in the header fields of this frame are compared with the values defined by the templates defined in the rules of the list in order to determine which processing operation is to be carried out for this frame.

The number of rules in an ACL may be very high, of the order of several hundred or even several thousand rules. It is therefore extremely costly in processing time to compare the header fields of a frame with each of the rules in an ACL.

The U.S. Pat. No. 6,651,096 describes a solution to this problem of processing time consisting in constructing a binary decision tree according to the ordered list of rules used for access control. In this solution, the processing of the frames assumes the bit to bit test of various header fields of a frame based on the binary decision tree constructed. In addition, this solution requires a specific hardware technology known as CAM (Content Addressable Memory).

However, the use of bit-by-bit processing of the frames assumes the use of the operations for masking the bytes of the frames to be processed, so as to access the various bits of data to be analyzed. Furthermore, the use of a binary decision tree assumes the implementation of a bit test function for each node of the tree, a fact which increases the complexity of writing a set of software codes implementing the corresponding automaton. Lastly, the construction of such a tree is tedious and consumes a large amount of memory as the number of rules in the list gets higher. Moreover, this solution requires specific hardware in order to try and minimize performance problems.

One of the aims of the invention is to overcome the shortcomings and drawbacks of the prior art and/or to provide improvements to it.

For this purpose, the subject of the invention is, according to a first aspect, a method for classifying data packets according to an ordered list of at least one classification rule, comprising a step for determining, for each data packet to be processed, an associated category of packet,
a said classification rule defining, on the one hand, a criterion relating to at least one data field present in the packets to be classified and, on the other, a category of packet intended to be associated with a packet whose said at least one data field contains a value matching said criterion,
the method being characterized in that the category associated with a packet is identified by a classification value determined in a predetermined number NB of iterations starting from an initial classification value and as a function of NB data blocks of the packet to be processed,
the set of said NB data blocks including the field or fields of data used for the definition of the rules in said list, the size of said data blocks being chosen from amongst a set of several sizes of block,
an iteration comprising a step for determination of a current classification value starting from the classification value obtained in the preceding iteration and from the value contained in the i^{th} data block, the order in which said data blocks are considered being predetermined.

Thanks to the invention, the time for processing a packet is reduced to the time for processing these NB data blocks. In particular, the time required for determining the action associated with a packet is independent of the contents of this packet.

Furthermore, the size of the blocks used to process a packet can be chosen from various sizes, notably sizes of block greater than or equal to 2 bits. This means that the number of iterations needed to process a packet may be reduced to one iteration per packet by choosing a block size that is sufficiently large.

Moreover, when the block size chosen is 8, 16 or 24 bits, it becomes unnecessary to apply bit masking operations in order to process a packet. The processing time for a packet is therefore reduced with respect to the known prior art solutions.

The invention thus teaches that it is possible to implement classification of the packets by processing these packets block by block, with any block size and in a predetermined number of iterations, which depends on the block size chosen. It teaches a processing method for the classification rules allowing such a packet classification technique to be implemented.

According to one embodiment, during the i^{th} iteration, where i is an integer such that 1≦i≦NB, a current classification value is determined by reading, in a table identified by the classification value obtained in the preceding iteration, the classification value associated with the value of the i^{th} data block of the packet in question.

No test operation is required, but only an operation for reading a value in a table. The time for processing a data packet is therefore equal to NB times the time to read a value in a table, and it is thus reduced to the minimum.

According to one embodiment, the method according to the invention comprises a step for the generation, starting from said list, of a directed acyclic graph with NB depth levels, said graph being representative of a state automaton, a said classification value identifying a state of said automaton, said initial classification value identifying the initial state of said automaton, the transition table for a state of level p−1 of the automaton, where p is an integer such that 1≦p≦NB, being a function between the set of the possible values of the p^{th} data block and the set of the state identifiers of level p.

The ordered list of rules used as a basis for the packet classification is transformed into a single unit representation, in the form of a graph with NB depth levels, whatever the number of rules in the list. This graph represents a state automaton which is that implemented for the processing of the packets to be filtered. This results in a high efficiency of processing for the packets, since even when the number of rules in the list is high, the depth of the graph is limited to NB levels.

According to one embodiment, the method according to the invention also comprises a step for construction of a list-degenerate graph with NB depth levels based on each of the rules in said list, said directed acyclic graph being obtained by the joining of the degenerate graphs constructed, a list-degenerate graph representing an automaton with states and NB transitions.

Each rule in the ordered list of rules is thus taken into account in the generation of the directed acyclic graph. The process of construction of this graph being based on a technique of joining of graphs which can readily be implemented by a program.

According to one embodiment, the method according to the invention comprises in which said joining is an iterative process, each iteration comprising a step for obtaining a current graph by the joining of a list-degenerate graph with the graph obtained at the preceding iteration and a step of minimization of said current graph.

For this reason, the process of construction of the directed acyclic graph consumes very little memory, since an incremental construction of this graph is possible.

According to one embodiment, the method according to the invention comprises comprising a step consisting in translating the criterion for each of the classification rules of said list into a list of NB sets of data block values, in such a manner that a data packet matches this criterion if and only if, for each integer p such that 1≦p≦NB, the value contained in the p^{th} data block of this packet is comprised in the p^{th} set of values, the p^{th} set of values comprising the value or values which a transition exists between the ^{th} state and the p^{th} state of the automaton represented by the list-degenerate graph obtained based on the rule in question.

Each of the rules from the ordered list of rules is thus translated simply into a list-degenerate graph by identification of the various sets of values respectively associated with the data blocks to be processed. This leads to the possibility of an automation of the process of generation of the associated list-degenerate graphs.

Another subject of the invention is a device for classifying data packets according to an ordered list of at least one classification rule, comprising means for determining, for each data packet to be processed, an associated category of packet,
a said classification rule defining, on the one hand, a criterion relating to at least one data field present in the packets to be classified and, on the other, a category of packet intended to be associated with a packet whose said at least one data field contains a value matching said criterion,
said means are designed to determine a classification value identifying the category associated with a packet in a predetermined number NB of iterations starting from an initial classification value and as a function of NB data blocks of the packet to be processed,
the set of said NB data blocks including the data field or data fields used for the definition of the rules in said list, the size of said data blocks being chosen from amongst a set of several sizes of block,
an iteration comprising a step for determining a current classification value starting from the classification value obtained in the preceding iteration and from the value contained in the i^{th} data block, the order in which said data blocks are considered being predetermined.

The advantages stated for the method according to the invention are directly transposable to the device according to the invention.

According to one embodiment, said means are designed to determine, during the i^{th} iteration, where i is an integer in the range between 1 and NB, a current classification value which is determined by reading, in a table identified by the classification value obtained in the preceding iteration, the classification value associated with the value of the i^{th} data block of the packet in question.

According to a preferred embodiment, the various steps of the method according to the invention are implemented by a software application or computer program, this application comprising software instructions intended to be executed by a data processor of a packet classification device and designed to control the execution of the various steps of this method.

Accordingly, the invention is also aimed at a program, capable of being executed by a computer or by a data processor, this program comprising instructions for controlling the execution of the steps of a method such as that mentioned hereinabove.

This program may use any type of programming language, and may be in the form of source code, object code, or code intermediate between source code and object code, such as in partially compiled form, or in any other desired form. A hardware or firmware implementation is equally possible.

The invention is also aimed at an information medium readable by a computer or data processor, and comprising instructions of a program such as that mentioned hereinabove.

The information medium can be any entity or device capable of storing the program. For example, the medium may comprise a storage means, such as a ROM, for example a CD ROM or a solid-state ROM, or else a magnetic recording means, for example a diskette (floppy disk) or a hard disk.

Furthermore, the information medium may be a transmissible medium such as an electrical or optical signal, which can be carried via an electrical or optical cable, by radio or by other means. The program according to the invention may, in particular, be uploaded onto a network of the Internet type.

Alternatively, the information medium may be an integrated circuit into which the program is incorporated, the circuit being designed to execute or to be used in the execution of the method in question.

Other aims, features and advantages of the invention will become apparent by way of the description that follows, presented solely by way of non-limiting example and with reference to the appended drawings in which:

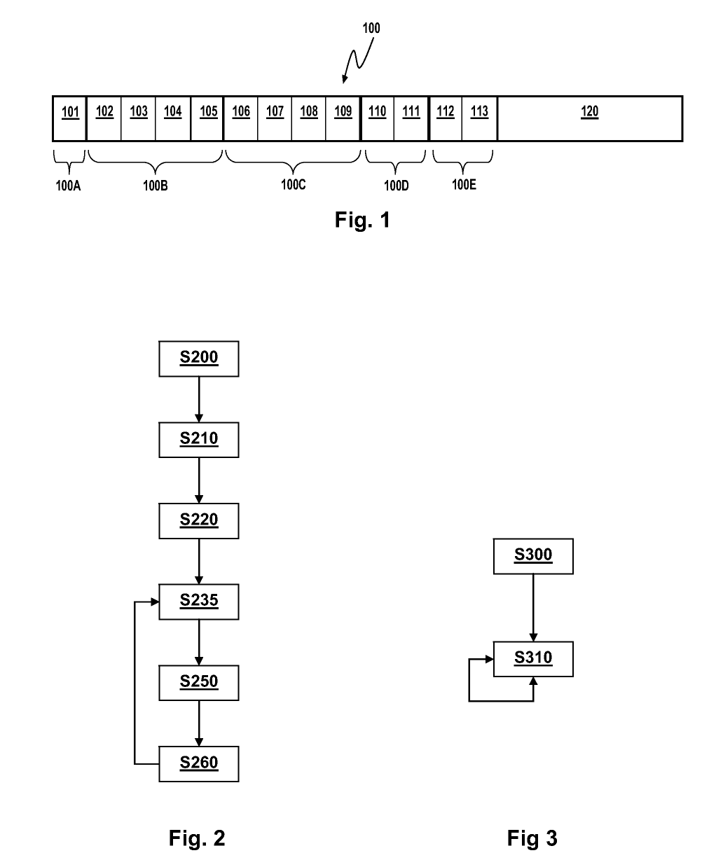

FIG. 1 shows schematically a data packet intended for filtering according to the method according to the invention;

FIG. 2 is a flow diagram of an embodiment of a first phase of the method according to the invention;

FIG. 3 is a flow diagram of an embodiment of a second phase of the method according to the invention;

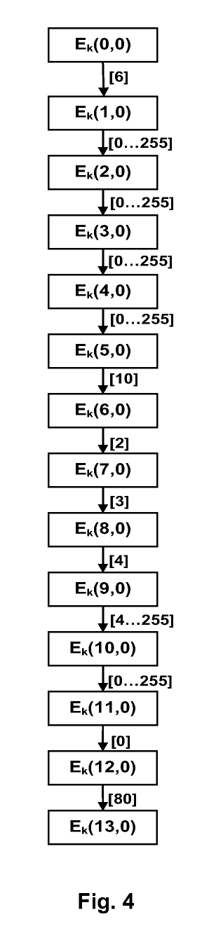

FIG. 4 shows a list-degenerate graph obtained based on a classification rule;

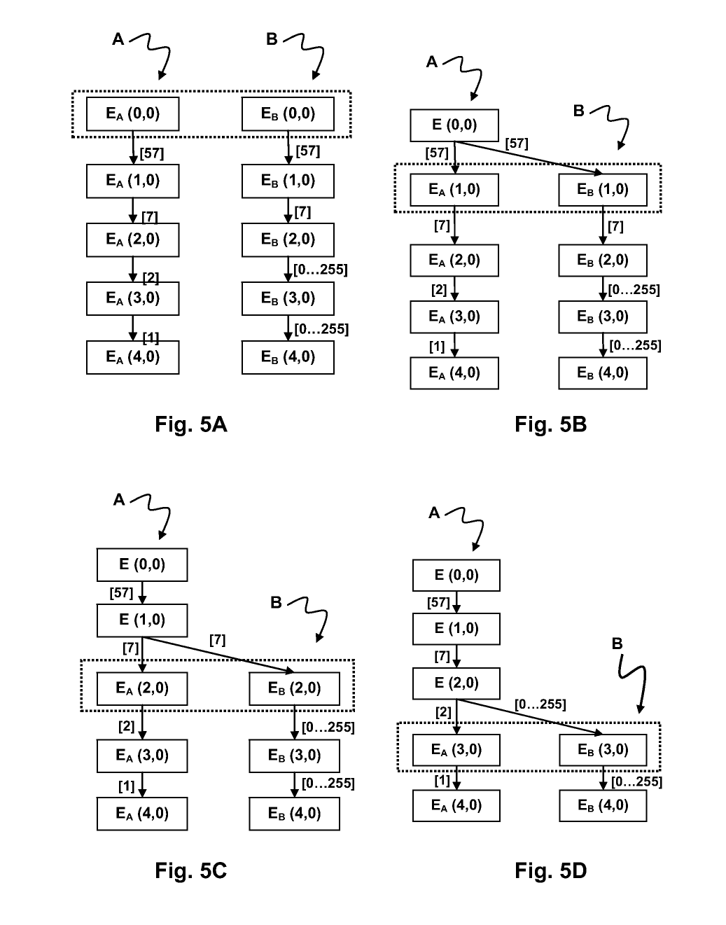

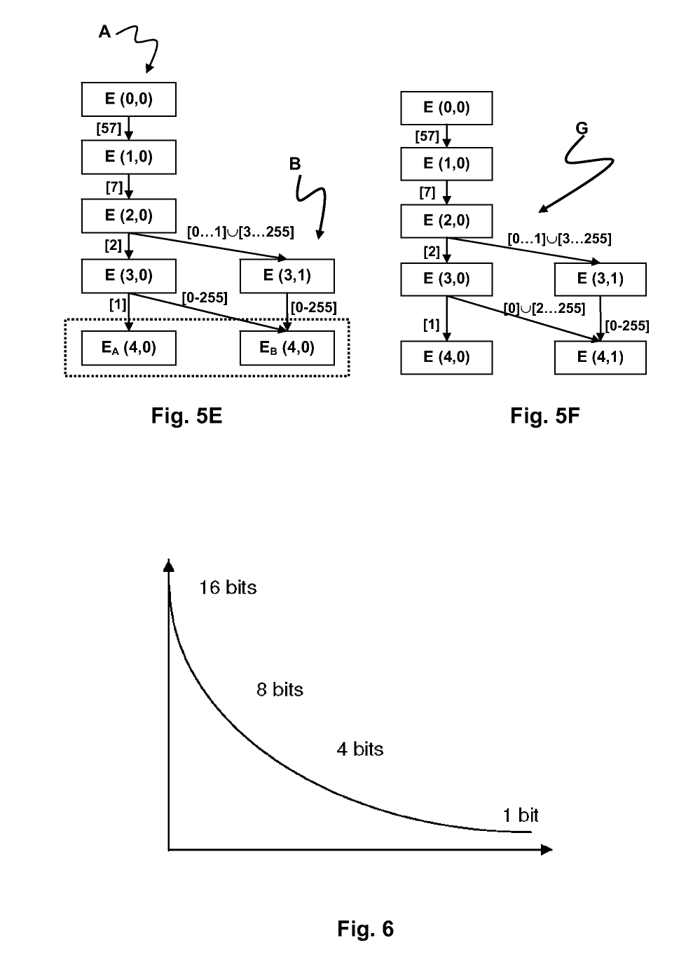

FIGS. 5A to 5F show various graphs obtained using an ordered list of rules at various stages of processing during the implementation of the method according to the invention;

FIG. 6 is a curve illustrating the performance of the method according to the invention;

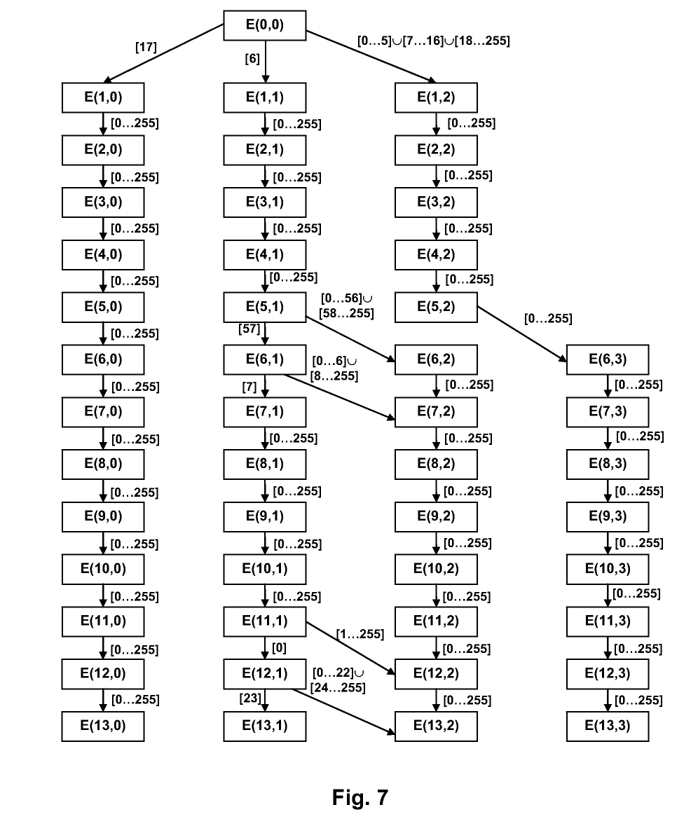

FIG. 7 shows a graph obtained based on an ordered list of rules.

The invention is described in more detail for the case of its application to the classification of data packets in the form of IP frames. The invention is however applicable to any other format of data packets and whatever the communications protocol used for the transmission of these packets.

In the case of an IP frame, shown schematically in FIG. 1, the data packet 100 comprises, in its header, various data fields as a function of whose values the classification of the frames is carried out according to an ordered list of rules, forming an access control list. These data fields are as follows:
a first field 100A comprising a protocol identifier allowing a protocol to be identified from amongst a list of possible protocols, this list comprising for example the protocols TCP (Transmission Control Protocol), UDP (User Datagram Protocol), IP (Internet Protocol); this field is coded over one byte identified by the reference 101;
a second field 100B comprising a source address, identifying a device transmitter of the packet; this field is coded over 4 bytes identified, respectively, by the references 102, 103, 104 and 105;
a third field 100C comprising a destination address, identifying a destination device for the packet; this field is coded over 4 bytes identified, respectively, by the references 106, 107, 108 and 109;
a fourth field 100D comprising a source communications port identifier, relating to the device transmitting the packet; this field is coded over 2 bytes identified, respectively, by the references 110 and 111;
a fifth field 100E comprising a destination communications port identifier, relating to the destination device for the packet; this field is coded over 2 bytes identified by the references 112 and 113, respectively.

The size in number of bits of these various fields is variable: the first data field is usually coded over 8 bits (i.e. one byte), the second and third fields are each coded over 32 bits (i.e. 4 bytes), whereas the fourth and fifth fields are coded over 16 bits (i.e. 2 bytes).

As will become apparent hereinbelow, the size of these data fields is of little importance, the method according to the invention processing the header of a packet block by block, for example byte by byte, potentially using a size of data block different, and hence independent from the size of the data fields used for interpreting the values contained in these blocks. Indeed, the method according to the invention implements an automated processing of the values taken by these various fields, this processing not requiring any interpretation of these values.

Furthermore, the order in which these data fields are recorded within a packet may be different, and is therefore independent from the order in which these data fields are processed by the method according to the invention. Preferably, however, the various data blocks of the header of a packet will be processed in the order in which they are written within this packet, in such a manner as to make the reading of these data blocks, for their processing, linear and therefore fast.

The ordered lists of rules usually used for the filtering of IP packets are known under the Anglo-Saxon designation “Access Control List” (ACL). Each of the rules of such a list defines a criterion for at least one of the header fields of a packet and an associated action, which action is to be applied to the packet—or to the data stream to which this packet belongs—for which the value or values of the data field or data fields in question match this criterion. In other words, a rule defines a category of packet to be assigned to a packet or data stream matching the criterion defined by this rule.

For example, the classification rule coded by the following expression:
Permit tcp any gt 1023 10.2.3.4 eq 80 log

means that the category “permit-log” (meaning that the stream is authorized to transit through the device implementing the packet classification) is assigned to any data stream using the “tcp” protocol, originating from any source address ('any'), starting from a source port strictly greater than 1023 and transmitted to the address 10.2.3.4 on the destination port 80.

The category of packet to which a packet is assigned also depends on the semantic used together with the order in which the rules of a list of rules are run and tested for this packet. The running order of the list of rules defines whether this list is taken starting with the first rule (order known as “top-down”) or with the last rule (order referred to as “bottom-up”). The semantic determines the conditions for interrupting the process of running the list:
either: the list of rules is run rule by rule until the packet being processed matches the criterion defined by the current rule; in this case, it is said that a semantic referred to as “first match” type is applied, in that it is the first rule for which there is a matching of the criterion defining the category to which this packet is assigned;
or: the list of rules is run rule by rule in order to determine the last rule whose criterion is matched by the packet being processed; in this case, it is said that a semantic referred to as “last match” type is applied, in that it is the last rule for which there is a matching of the criterion defining the category to which this packet is assigned.

A semantic referred to as “best match” (longest prefix) type may also be envisioned: this consists in running through the entire list of rules and in selecting the best rule, in other words that for which the packet best matches the associated criterion. This type of semantic assumes that a method will be defined for calculating a parameter constituting a measurement of optimal match for the verification test for a criterion and for determining for which rule the value of this parameter is the highest.

It should be noted that the use of the semantic “first match” and of the order “top-down” for the running of a list of rules produces the same result, in terms of category of packet, as the use of the semantic “last match” and of the order “bottom-up” for the execution of this same list.

Similarly, the use of the semantic “last match” and of the order “top-down” for the running of a list of rules produces the same result, in terms of category of packet, as the use of the semantic “first match” and of the order “bottom-up” for the execution of this same list.

The method according to the invention comprises two phases. The first phase corresponds to the generation, based on an ordered list of rules, of data representative of a directed acyclic graph (DAG) modeling a finite-state automaton (DFA). The second phase of the method according to the invention consists in classifying the packets by implementation of a state automaton represented by the graph constructed.

In a known manner, and as illustrated for example in FIG. 7, a graph, as a representation, is composed of nodes, represented here by rectangles, and of arcs between these nodes, represented here by arrows. Such a graph is used to represent schematically the behavior of a finite-state automaton, each state of the automaton being represented by a node of the graph, a transition between two states being represented by an arc between the corresponding nodes. In order to simplify the description, the terms ‘states’ and ‘transitions’ will also be mentioned in relation to a graph.

The following notations are used in the following part of the document:
LR ordered list of rules (ACL)
NR number of rules in the list LR
Rₖ k^{th} rule of the list LR, where k is an integer in the range between 1 and NR
SB size of a data block of a packet
NB number of data blocks of size SB to be processed
xᵢ value contained in the i^{th} data block of a packet where i is an integer in the range between 1 and NB
Vᵢ set of possible values of the i^{th} data block of a packet (0 . . . 2^{SB}−1)
Z state automaton
G directed acyclic graph modeling the automaton Z
E(0,0) identifier of the initial state of the automaton Z, this state being represented by the root of the graph G
E(p,q) identifier of the state of the automaton Z, this state being represented in the graph G by a node numbered q and located at the depth p in the graph G
T_{E(p,q)} transition table in the automaton Z for the state E(p,q)
e identifier of the current state (current classification value)
Tₑ transition table in the automaton Z for the state e
Tₑ(xᵢ) classification value associated with the value xᵢ by the transition table Tₑ
[a . . . b] set of the non-negative integer numbers n such that a≦n≦b
[a] singleton containing the non-negative integer a

In FIG. 7, the set of values indicated beside each arrow connecting two rectangles, respectively representing a state, indicate for which data block values a transition between these two states is possible. For example, between the state E(0,0) and the state E(1,1) a transition is possible for a block value of ‘6’. Between the state E(0,0) and the state E(1,2), a transition is possible for all the block values included in the set: [0 . . . 5]∪[7 . . . 16]∪[18 . . . 255].

As will be described in more detail below, the choice, from amongst the possible transitions, of the current transition to be used in order to go from a state of depth (p−1) to the next state of depth p depends, in the invention, on the value contained in the p^{th} data block of the data packet being processed. In the context of the invention, a deterministic automaton is constructed, in other words an automaton for which the possible transitions starting from one state are defined in a non-ambiguous manner, in other words where only one transition is possible for a given value of data block.

In the context of the invention, the graph constructed is a directed graph (i.e. the transitions are only effected in one direction, and it is not possible to return to the initial state) and acyclic (i.e. the transitions between states do not allow the graph to be run in a loop, but only in the direction of the final states of the graph).

The graph used in the invention also possesses other properties: on the one hand, it comprises a single initial state; on the other, the number of transitions to be carried out in order to reach one of the final states starting from this single initial state is constant, whichever transitions are carried out in order to run through the graph. For this reason, the depth in the graph of a state is equal to the number of transitions needed in order to reach this state starting from the initial state. By convention, the initial state is at the depth 0, and the depth is incremented by one unit at each new transition. Such a graph DAG is a minimization of a tree.

The invention shows that it is possible to construct a graph in order to represent all the rules of an ordered list of rule, while at the same time taking into account the semantic used during the application of the rules to a data packet. In the method according to the invention, for each data packet to be classified, the graph is run starting from the initial state, the transition used to go from a state of level p−1 to level p (where 1≦p≦NB) being determined by the value contained in the p^{th} data block of a packet. This mode of running through the graph leads to one of the final states of the graph, with which final state is associated a category of packet.

This category of packet is for example used to identify an action to be carried out on the packet in question: an area of memory in which the packet or the data stream to which the packet belongs is stored, a particular processing operation to be carried out on the packet or the data stream to which the packet belongs, etc. It is thus possible to process the various packets or data stream received in a differentiated manner, on the basis of the identifier of the final state at which the execution of the graph has ended up for the packet in question.

For convenience, an identifier E(p,q) is assigned to each of the states of the graph, where p is the depth level at which this state is located in the graph and q an index allowing the various states situated at a given depth level to be distinguished. For the implementation of the invention, the identifier of a state is a data value used in the invention as classification value, since such an identifier is used to determine a category of packet to which the packet being processed needs to be assigned.

The transition from one state to another, starting from a state of given depth p, is a function of the value of the block xₚ of the packet to be processed. In other words, when running through the graph for the processing of a data packet, at each depth level p of the graph, whatever the current state at this depth level in the graph, the value contained in the block xₚ of the packet to be processed determines which is the next state, of level p+1, in the execution of the graph.

It is therefore possible to define an association function, representing the transition table T_{E(p,q)} of a state E(p,q). This association function is a function of the set Vₚ of the possible values for the p^{th} data block toward the set of the identifiers Eₚ₊₁ of the identifiers of the states of level p+1, which associates with each value v of Vₚ a state identifier e from the set of the identifiers Eₚ₊₁ such that:

e=T_{E(p,q)}(v)

In the case where the data block to be processed is a byte, the set Vₚ of the possible values for this block is the set of the values 0 to 255. In the case where no transition is possible or defined for a value of the set of data Vₚ, an identifier whose value is indicative of a non-existent transition, for example an identifier of zero value, is used in the transition table T_{E(p,q)}.

Since the function of a transition table is to enable the classification of the packets to be processed, such a table is here also referred to as ‘classification table’.

Generation of a Directed Acyclic Graph (DAG)

The first phase of the method according to the invention corresponds to the generation, based on an ordered list LR of NR rules, of a directed acyclic graph, which is representative of an automaton enabling the classification of packets. This phase corresponds to the steps S200 to S260 shown in the flow diagram in FIG. 2.

At step S200, the block size SB to be used is chosen from amongst a set of possible values. It is preferably chosen to be greater than or equal to 2 bits and less than or equal to a maximum useful size equal to the sum of the sizes of the data fields used in the definition of the rules in the list LR. It is possible to choose a larger size, but this will be to the detriment of the performance of the algorithm and will increase the total size of the memory required for the storage of the data used to represent the graph G. In the case of an IP packet, the maximum useful size is 13*8=104 bits, since the packet header fields used for the definition of the classification rules are coded over 13 bytes (protocol, source address, destination address, source port, destination port). Other fields may potentially be added or removed depending on the application context.

The curve shown in FIG. 6 illustrates the influence of the choice of the block size on the complexity in time and in memory of the algorithm for construction of the graph. In this figure, the vertical axis represents the processing time and the horizontal axis the amount of memory required. The smaller the block size and the closer to 1 bit, and the smaller the amount of memory required for the construction of the graph, the longer however will be the time for construction of this graph. In contrast, the larger the block size, and the larger the amount of memory required for the construction of the graph, the shorter however will be the time for construction of this graph. The reason for this is that, with a block size SB=1 bit, the graph G will comprise 13*8=104 depth levels and a transition table with 2¹=2 entries for each state, whereas with a block size SB=104 bits, the graph comprises one and only one depth level starting from the initial state and a transition table with 2¹⁰⁴ entries for the initial state.

In the example described hereinbelow, it is assumed that the block size SB is chosen equal to 8 bits, this value allowing a good compromise to be obtained between the amount of memory used and the processing time required. Furthermore, a block size of 8 bits allows the data to be processed byte by byte, which is well adapted to the design of a data processing computer. Indeed, such a processor is designed to carry out high-speed operations on bytes, or on data blocks of sizes that are multiples of 8.

It should be noted here that a block size less than 8 bits or that would not be a multiple of 8 involves the use of bit masking functions when processing the data fields of the packet; this will increase the time required for processing the packets.

Since the block size is chosen equal to 8 in the example described, the header of a packet is processed byte by byte and the number NB of data blocks to be processed for each packet is therefore equal to 13.

The order in which the data blocks are processed is also predetermined and chosen at step S200. It is assumed here that the various data blocks of the header of a packet will be processed in the order in which they are written into this packet, in such a manner as to make the reading of these data blocks, for their processing, linear and hence faster.

The set of NB data blocks to be processed comprises at least the set of data fields used for the definition of the rules. Preferably, this set of blocks exactly corresponds to the set of fields in question. However, when a block size different from 1 bit is used, for example a block size equal to 8 bits, and when all of the fields in question are not multiples of this chosen block size, a number of blocks must be chosen that is sufficient for all of the fields in question to be included in this set of blocks. There are therefore cases where the total number of bits in the set of blocks is greater than the total number of bits in the fields in question, the bits of the data blocks not corresponding to any field being able to take any given values. However, the method is applicable also in this case, since here it suffices to define the sets of values associated with each block in a suitable manner (see step S210).

In the example described here, illustrated in FIG. 1, the set of the NB=13 data blocks 101 to 113 exactly corresponds to the set of the data fields 100A to 100E.

In this example:
the block denoted x₁, with reference 101, corresponds to the field 100A (protocol);
the blocks denoted x₂ to x₅, with references 102 to 105, correspond to the field 100B (source address);
the blocks denoted x₆ to x₉, with references 106 to 109, correspond to the field 100C (destination address);
the blocks denoted x₁₀ to x₁₁, with references 110 to 111 correspond to the field 100D (source port);
the blocks denoted x₁₂ to x₁₃, with references 112 to 113 correspond to the field 100E (destination port).

At step S210, each rule Rₖ of the list LR, for 1≦k≦NR where NR is the number of rules in the list LR, is translated into a list of NB sets of values coded over a number of bits equal to the block size chosen at step S200. Each set of values is associated with a data block to be processed and contains possible values for this block. The sets of data are such that a data packet matches the classification criterion defined by the rule Rₖ if and only if, for each integer p such that 1≦p≦NB, the value contained in the p^{th} data block of this packet is included within the p^{th} set of values.

For example, the classification rule Rₖ expressed by the following expression:
Permit tcp any gt 1023 10.2.3.4 eq 80 log(Rₖ)

means that the category “permit-log” (meaning that the stream is authorized to pass through the equipment implementing the filtering of the packets) is assigned to any data stream using the “tcp” protocol, coming from any given source address ('any'), starting from a source port strictly greater than 1023 and transmitted to a destination address 10.2.3.4 on the destination port 80.

The NB=13 sets of values associated with this rule and with each of the data blocks are therefore:
Data block x₁: [6]
Data block x₂: [0 . . . 255]
Data block x₃: [0 . . . 255]
Data block x₄: [0 . . . 255]
Data block x₅: [0 . . . 255]
Data block x₆: [10]
Data block x₇: [2]
Data block x₈: [3]
Data block x₉: [4]
Data block x₁₀: [4 . . . 255]
Data block x₁₁: [0 . . . 255]
Data block x₁₂: [0]
Data block x₁₃: [80]

Indeed,
for the first block x₁, only the block value ‘6 ’ is possible because this value means that the protocol used is TCP;
for the bytes x₂ to x₅, all the values are possible since any source address is possible; the associated set is therefore the set of the integer values from 0 to 255;
for the block x₆, only the block value ‘10 ’ is possible owing to the constraint imposed on the first byte of the destination address, which constraint follows from that defined in the rule on the destination address (=10.2.3.4);
for the block x₇, only the block value ‘2 ’ is possible owing to the constraint imposed on the second byte of the destination address (=10.2.3.4);
for the block x₈, only the block value ‘3 ’ is possible owing to the constraint imposed on the third byte of the destination address (=10.2.3.4);
for the block x₉, only the block value ‘4 ’ is possible owing to the constraint imposed on the fourth byte of the destination address (=10.2.3.4);
for the block x₁₀, only the values 4 to 255 are possible owing to the constraint imposed on the first byte of the source port, which constraint follows from that defined in the rule on the source address (>1023);
for the block x₁₁, all the values are possible owing to the constraint imposed on the second byte of the source port (>1023);
for the block x₁₂, only the block value ‘0 ’ is possible owing to the constraint imposed on the first byte of the destination port, which constraint follows from that defined in the rule on the destination address (=80);
for the block x₁₃, only the block value ‘80 ’ is possible owing to the constraint imposed on the second byte of the destination port (=80).

Those skilled in the art will readily generalize the way of constructing these sets of possible values to the various cases encountered for the definition of a classification rule.

At step S220, a list-degenerate graph is constructed for each rule Rₖ in the list LR, based on the sequence of the NB sets of values obtained at step S210 for this rule. This list-degenerate graph represents the rule Rₖ. This graph comprises an initial state denoted Eₖ(0,0) and NB other states denoted Eₖ(p,0) successively connected to one another, where p is an integer in the range between 1 and NB, identifying the depth of the state in the graph, a depth whose value is determined starting from the initial state incrementing by 1 at each transition to the next state. This graph represents an automaton associated with the rule Rₖ.

The list-degenerate graph obtained based on the rule Rₖ, given as an example hereinabove, is shown schematically in FIG. 4.

In this degenerate graph, the transition from a state Eₖ(p,0) to the next state Eₖ(p+1,0) is defined by a transition table T_{E}_{ₖ}_{(p,0)} associated with the state Eₖ(p,0), where 1≦p≦NB. This transition table T_{E}_{ₖ}_{(p,0)} defines an association function between the set of the possible values of the data block xₚ and the set of the identifiers for the states of level p+1 in the list-degenerate graph. In the case of this list-degenerate graph, there only exists a transition to the state Eₖ(p+1,0) starting from the state Eₖ(p,0) for the data block values included in the set of data block values associated with the block xₚ, this set having been determined at step S210. The transition table T_{E}_{ₖ}_{(p,0)} associated with the state Eₖ(p,0) therefore contains, for the data block values included in the set of data block values associated with the block xₚ, the identifier of the state Eₖ(p+1,0) and, for the other data block values, an identifier whose value is indicative of a non-existent transition, for example an identifier with zero value.

In the list-degenerate graph shown in FIG. 4, representing the rule Rₖ, the transition tables T_{E}_{ₖ}_{(p,0)} for the states Eₖ(p,0), for 0≦p<13, are defined as follows:

$$\{ \begin{matrix}∀ v ∈ [ 0 … 5 ] ⋃ [ 7 … 255 ] {T}_{{E}_{k} ( 0 , 0 )} ( v ) = 0 \\ {T}_{{E}_{k} ( 0 , 0 )} ( 6 ) = {E}_{k} ( 1 , 0 )\end{matrix} \\ \{ ∀ v ∈ [ 0 … 255 ] {T}_{{E}_{k} ( 1 , 0 )} ( v ) = {E}_{k} ( 2 , 0 ) \\ \{ ∀ v ∈ [ 0 … 255 ] {T}_{{E}_{k} ( 2 , 0 )} ( v ) = {E}_{k} ( 3 , 0 ) \\ \{ ∀ v ∈ [ 0 … 255 ] {T}_{{E}_{k} ( 3 , 0 )} ( v ) = {E}_{k} ( 4 , 0 ) \\ \{ ∀ v ∈ [ 0 … 255 ] {T}_{{E}_{k} ( 4 , 0 )} ( v ) = {E}_{k} ( 5 , 0 ) \\ \{ \begin{matrix}∀ v ∈ [ 0 … 9 ] ⋃ [ 11 … 255 ] {T}_{{E}_{k} ( 5 , 0 )} ( v ) = 0 \\ {T}_{{E}_{k} ( 5 , 0 )} ( 10 ) = {E}_{k} ( 6 , 0 )\end{matrix} \\ \{ \begin{matrix}∀ v ∈ [ 0 … 1 ] ⋃ [ 3 … 255 ] {T}_{{E}_{k} ( 6 , 0 )} ( v ) = 0 \\ {T}_{{E}_{k} ( 6 , 0 )} ( 2 ) = {E}_{k} ( 7 , 0 )\end{matrix} \\ \{ \begin{matrix}∀ v ∈ [ 0 … 2 ] ⋃ [ 4 … 255 ] {T}_{{E}_{k} ( 7 , 0 )} ( v ) = 0 \\ {T}_{{E}_{k} ( 7 , 0 )} ( 3 ) = {E}_{k} ( 8 , 0 )\end{matrix} \\ \{ \begin{matrix}∀ v ∈ [ 0 … 3 ] ⋃ [ 5 … 255 ] {T}_{{E}_{k} ( 8 , 0 )} ( v ) = 0 \\ {T}_{{E}_{k} ( 8 , 0 )} ( 4 ) = {E}_{k} ( 9 , 0 )\end{matrix} \\ \{ \begin{matrix}∀ v ∈ [ 0 … 3 ] {T}_{{E}_{k} ( 9 , 0 )} ( v ) = 0 \\ ∀ v ∈ [ 4 … 255 ] {T}_{{E}_{k} ( 9 , 0 )} ( v ) = {E}_{k} ( 10 , 0 )\end{matrix} \\ \{ ∀ v ∈ [ 0 … 255 ] {T}_{{E}_{k} ( 10 , 0 )} ( v ) = {E}_{k} ( 11 , 0 ) \\ \{ \begin{matrix}∀ v ∈ [ 1 … 255 ] {T}_{{E}_{k} ( 11 , 0 )} ( v ) = 0 \\ {T}_{{E}_{k} ( 11 , 0 )} ( 0 ) = {E}_{k} ( 12 , 0 )\end{matrix} \\ \{ \begin{matrix}∀ v ∈ [ 0 … 79 ] ⋃ [ 81 … 255 ] {T}_{{E}_{k} ( 12 , 0 )} ( v ) = 0 \\ {T}_{{E}_{k} ( 12 , 0 )} ( 80 ) = {E}_{k} ( 13 , 0 )\end{matrix}$$

The various degenerate graphs are assembled into a list in a single graph G during the following steps S235 to S260. A simple joining of the degenerate graphs, consisting in attaching all these graphs to the same initial state, leads to the construction of a graph representing an automaton which is non-deterministic in the sense that several transitions are possible starting from the initial state. The method according to the invention brings together these degenerate graphs in such a manner as to produce a final graph that is representative of a deterministic automaton.

The process of joining of these graphs is iterative. During the first iteration, on the first execution of step S235, the first two degenerate graphs representative of the first two rules from the list of rules to be processed are joined together. Step S250 is executed following step S235.

Then, at each subsequent iteration, in other words at each execution of step S235, the list-degenerate graph obtained from the following rule in the list of rules is joined together with the graph obtained at the preceding step S260.

The process of joining used in the invention is described in more detail hereinbelow.

At step S250, the graph obtained at the preceding step S235 is minimized. The process of minimization of a graph which is applied in the invention consists in merging two equivalent states into one single state, each time that two equivalent states are detected in the graph. The process is successively applied at each of the depth levels, and independently level by level (states belonging to different depth levels cannot be equivalent). Preferably, the highest depth level is processed first, i.e. the final states, since this allows the processing time required for the minimization to be significantly reduced.

Two final states are equivalents if the actions respectively associated with them are identical. Two non-final states are equivalent if they have the same transition table, in other words if they point toward the same states for the same block values.

The merging of two states during the process of minimization amounts, in a known manner, to eliminating one of the two states and to conserving the other, then in making the states of level immediately above, which initially point toward the eliminated state, point toward the conserved state. Such a merging operation does not require processing with the transition tables since they are identical.

Applying this process of minimization after each step S235 for the joining of a list-degenerate graph with the global graph allows the total amount of memory and the time required for the construction of the graph to be reduced. However, it is also possible to only carry out this minimization on the final graph, when all the degenerate graphs in a list have been assembled into one and the same graph, in other words following the last execution of step S260.

Following step S250, step S260 is executed during which it is determined whether all the degenerate graphs in the list have been processed. In the affirmative, the first phase of the method according to the invention has ended. Otherwise, step S235 is executed for the next graph generated in the list corresponding to the next rule in the list LR of rules.

In the example of the application of the method according to the invention to the following list of rules:

Permit tcp any 57.7.0.0 0.0.255.255 eq telnet

Deny tcp any any

Deny udp any any log

Permit udp host 1.2.3.4 host 5.6.7.8

Permit ip any any log

the graph obtained is that shown in FIG. 7.

In this graph, the majority of the states have a single transition table, since for all the values of the set [0 . . . 255] only one state is possible: that toward which the arrow points starting from the rectangle representing this state.

For the states for which several following states are possible according to the value of the block, the transitions tables are as follows:

$$\{ \begin{matrix}∀ v ∈ \{ 0 … 5 ] ⋃ [ 7 … 16 ] ⋃ [ 18 … 255 ] {T}_{E ( 0 , 0 )} ( v ) = E ( 1 , 2 ) \\ {T}_{E ( 0 , 0 )} ( 6 ) = E ( 1 , 1 ) \\ {T}_{E ( 0 , 0 )} ( 17 ) = E ( 1 , 0 )\end{matrix} \\ \{ \begin{matrix}∀ v ∈ [ 0 … 56 ] ⋃ [ 58 … 255 ] {T}_{E ( 5 , 1 )} ( v ) = E ( 6 , 2 ) \\ {T}_{E ( 5 , 1 )} ( 57 ) = E ( 6 , 1 )\end{matrix} \\ \{ \begin{matrix}∀ v ∈ [ 0 … 6 ] ⋃ [ 8 … 255 ] {T}_{E ( 6 , 1 )} ( v ) = E ( 7 , 2 ) \\ {T}_{E ( 6 , 1 )} ( 7 ) = E ( 7 , 1 )\end{matrix} \\ \{ \begin{matrix}∀ v ∈ [ 1 … 255 ] {T}_{E ( 11 , 1 )} ( v ) = E ( 12 , 2 ) \\ {T}_{E ( 11 , 1 )} ( 0 ) = E ( 12 , 1 )\end{matrix} \\ \{ \begin{matrix}∀ v ∈ [ 0 … 22 ] ⋃ [ 24 … 255 ] {T}_{E ( 12 , 1 )} ( v ) = E ( 13 , 2 ) \\ {T}_{E ( 12 , 1 )} ( 23 ) = E ( 13 , 1 )\end{matrix}$$

The final states and their associated actions are respectively:

E(13,0) action “permit-log”

E(13,1) action “permit-nolog”

E(13,2) action “deny-log”

E(13,3) action “deny-nolog”

Classifying the Data Packets

The data packet classification process corresponds to the second phase of the method according to the invention. It is described with reference to FIG. 3. This phase consists in implementing an automaton Z whose graph G, obtained following the last execution of step S260, forms a representation. This process is implemented by a device, in the form of a software application or of hardware, which simulates the transitions of the graph for each of the states of this graph G.

At step S300, the current initial state of the device is the state identified by E(0,0) formed by the identifier of the initial state of the automaton Z, whichever data packet is to be classified. The classification process is then an iterative process, each of the later steps S310 of the classification process consisting in simulating a transition from the current state toward a new current state. In other words, each of the steps S310 consists in determining the identifier of the new current state based on the identifier of the current state.

In order to describe the classification process, the notation stated hereinafter is used. The current state of level p−1, 1≦p≦NB, in the graph is identified by the current classification value e such that:

e=E(p−1,q)

the transition table of the current state e is denoted:

Tₑ=T_{E(p-1,q)}

and the new current state during the implementation of the automaton Z is identified by:

e=Tₑ(xₚ)=T_{E(p-1,q)}(xₚ)

The classification process comprises exactly NB iterations, in other words NB steps 310. The iteration p for 1≦p≦NB consists in determining, based on the current classification value e and the value xₚ of the p^{th} data block, the new current classification value e such that e=Tₑ(xₚ). This value is obtained by simply reading the value Tₑ(xₚ) in the transition table Tₑ associated with the current state e.

The result of this is that however many rules there are in the list of rules, whichever data packet is to be processed, the time required to obtain the classification value (and hence the category) to be assigned to this packet is constant, equal to the time required to carry out NB read operations in a table. The processing time per packet is therefore very small and constant, in this case minimized since reduced to the reading of NB values, and therefore negligible with respect to the processing time required to process a packet rule by rule. In particular, there is no arithmetic operation to be performed on the values of the data blocks, nor even a test or comparison. Finally, the various values of the data blocks are successively processed, in an identical manner, whichever packet and whichever data block are to be processed.

In the case where, during the implementation of the automaton Z, an identifier whose value is indicative of a non-existing transition is obtained, for example an identifier of zero value, this means that there is no category of packet that may be assigned to the packet or data stream being processed. In such a situation, a particular processing outcome is provided: warning of the error, for example by display, recording in a file, with indication of the last state identifier at which the execution of the graph ended, application of a “default” rule, execution of a default action or else assignment to a default category.

The classification process terminates when the NB values of data blocks xₚ, for 1≦p≦NB, have been processed or when a zero state identifier is found.

Joining of Two Graphs

The process for joining together two graphs implemented in the execution of step S235 is described in more detail herein below. This process allows the two graphs to be assembled in such a manner as to obtain a single graph representative of a deterministic automaton. Such a process is known from the prior art and is described for example in the document by John E. Hoperoft, Rajeev Motwani, Rotwani and Jeffrey D. Ullman, entitled “Introduction to Automata Theory, Languages and Computability”, (Addison-Wesley Longman Publishing Co., Inc., Boston, Mass., 2000).

In the invention, this known process is adapted so as to take into account the semantic used in the utilization and the definition of the list of rules to be processed.

One simplified example of the joining of two graphs is described here with reference to FIGS. 5A to 5F. In this example, an access control list is considered that comprises the following two rules R_{A} and R_{B}, relating to the source address of a packet:
57.7.2.1 permit (R_{A})
57.7.*.* deny (R_{B})

The graphs A and B, that are list-degenerate, obtained respectively using the rules R_{A} and R_{B}, are shown in FIG. 5A.

In the graph A, the transition from the state E_{A}(0,0) to the state E_{A}(1,0) is only possible when the value of the first byte of the source address is ‘57 ’; in other words the transition table T_{E}_{_{A}}_{(0,0)} associated with the state E_{A}(0,0) defines an association function for the set [0 . . . 255] within the set of the state identifiers such that:

$$\{ \begin{matrix}∀ v ∈ [ 0 … 56 ] ⋃ [ 58 … 255 ] {T}_{{E}_{A} ( 0 , 0 )} ( v ) = 0 \\ {T}_{{E}_{A} ( 0 , 0 )} ( 57 ) = {E}_{A} ( 1 , 0 )\end{matrix}$$

In the same way, in the graph A, the transition from the state E_{A}(1,0) to the state E_{A}(2,0) is only possible when the value of the second byte of the source address is ‘7 ’; in other words the transition table T_{E}_{_{A}}_{(1,0)} associated with the state E_{A}(1,0) defines an association function for the set [0 . . . 255] within the set of the state identifiers such that:

$$\{ \begin{matrix}∀ v ∈ [ 0 … 6 ] ⋃ [ 8 … 255 ] {T}_{{E}_{A} ( 1 , 0 )} ( v ) = 0 \\ {T}_{{E}_{A} ( 1 , 0 )} ( 7 ) = {E}_{A} ( 2 , 0 )\end{matrix}$$

Similarly, the transition from the state E_{A}(2,0) to the state E_{A}(3,0) is only possible when the value of the third byte of the source address is ‘2 ’; in other words the transition table T_{E}_{_{A}}(2,0) associated with the state E_{A}(2,0) defines an association function for the set [0 . . . 255] within the set of the state identifiers such that:

$$\{ \begin{matrix}∀ v ∈ [ 0 … 1 ] ⋃ [ 3 … 255 ] {T}_{{E}_{A} ( 2 , 0 )} ( v ) = 0 \\ {T}_{{E}_{A} ( 2 , 0 )} ( 2 ) = {E}_{A} ( 3 , 0 )\end{matrix}$$

Lastly, the transition from the state E_{A}(3,0) to the state E_{A}(4,0) is only possible when the value of the fourth byte of the source address is ‘1 ’; in other words the transition table T_{E}_{_{A}}_{(3,0)} associated with the state E_{A}(3,0) defines an association function for the set [0 . . . 255] within the set of the state identifiers such that:

$$\{ \begin{matrix}∀ v ∈ [ 0 ] ⋃ [ 2 … 255 ] {T}_{{E}_{A} ( 3 , 0 )} ( v ) = 0 \\ {T}_{{E}_{A} ( 3 , 0 )} ( 1 ) = {E}_{A} ( 4 , 0 )\end{matrix}$$

As far as the graph B is concerned, the transition from the state E_{B}(0,0) to the state E_{B}(1,0) is only possible when the value of the first byte of the source address is ‘57’; in other words the transition table T_{E}_{_{B}}_{(1,0)} associated with the state E_{B}(0,0) defines an association function for the set [0 . . . 255] within the set of the state identifiers such that:

$$\{ \begin{matrix}∀ v ∈ [ 0 … 56 ] ⋃ [ 58 … 255 ] {T}_{{E}_{B} ( 0 , 0 )} ( v ) = 0 \\ {T}_{{E}_{B} ( 0 , 0 )} ( 57 ) = {E}_{B} ( 1 , 0 )\end{matrix}$$

In the same way, in the graph B, the transition from the state E_{B}(1,0) to the state E_{B}(2,0) is only possible when the value of the second byte of the source address is ‘7 ’; in other words the transition table T_{E}_{_{B}}_{(1,0)} associated with the state E_{B}(1,0) defines an association function for the set [0 . . . 255] within the set of the state identifiers such that:

$$\{ \begin{matrix}∀ v ∈ [ 0 … 6 ] ⋃ [ 8 … 255 ] {T}_{{E}_{B} ( 1 , 0 )} ( v ) = 0 \\ {T}_{{E}_{B} ( 1 , 0 )} ( 7 ) = {E}_{B} ( 2 , 0 )\end{matrix}$$

In the graph B, the transition from the state E_{B}(2,0) to the state E_{B}(3,0) is possible whatever the value of the third byte of the source address; in other words the transition table T_{E}_{_{B}}_{(2,0)} associated with the state E_{B}(2,0) defines an association function for the set [0 . . . 255] within the set of the state identifiers such that:

∀υε[0 . . . 255]T_{E}_{_{B}}_{(2,0)}(υ)=E_{B}(3,0)

Lastly, the transition from the state E_{B}(3,0) to the state E_{B}(4,0) is possible whatever the value of the fourth byte of the source address; in other words the transition table T_{E}_{_{B}}_{(3,0)} associated with the state E_{B}(3,0) defines an association function for the set [0 . . . 255] within the set of the state identifiers such that:

∀υε[0 . . . 255]T_{E}_{_{B}}_{(3,0)}(υ)=E_{B}(4,0)

The graphs A and B obtained, corresponding to the transition tables that have just been described, are shown in FIG. 5A.

In order to join together the graph A and the graph B, a non-deterministic state E(0,0) is created by merging the two initial states E_{A}(0,0) and E_{B}(0,0) of the graphs A and B, and the following notation is used for modeling this operation:

E(0,0)=<E_{A}(0,0);E_{B}(0,0)>

The state E(0,0) is a non-deterministic state in that in the graph thus obtained, as shown in FIG. 5B, when in the state E(0,0), this is either the state E_{A}(0,0) or the state E_{B}(0,0).

The state E(0,0) will be made deterministic by comparing and merging the two transition tables T_{E}_{_{A}}_{(0,0)} and T_{E}_{_{B}}_{(0,0)}, associated with the states E_{A}(0,0) and E_{B}(0,0) starting from which the state E(0,0) has been created, into a new transition table T_{E(0,0)}. In this way, for each value of the first byte of the source address, only one transition will be possible rather than two. In particular, in the example described, when the first byte of the source address takes the value ‘57 ’, there is an ambiguity in the following state, since the two transition tables T_{E}_{_{A}}_{(0,0)} and T_{E}_{_{B}}_{(0,0)} define a different state identifier for this value: E_{A}(1,0) for the first table and E_{B}(1,0) for the second.

The process of merging two transition tables TA and TB into one transition table T is as follows: for each of the values v of the set [0 . . . 255], the two state identifiers TA(v) and TB(v) defined by TA and TB, respectively, are examined, and:
if TA(v)=0 then T(v)=TB(v)
otherwise if TB(v)=0 then T(v)=TA(v)
otherwise a new state T(v) is created, that is non-deterministic, resulting from the merging of the states TA(v) and TB(v), denoted as T(v)=<TA(v), TB(v)>.

In the case of the transition tables T_{E}_{_{A}}_{(0,0)} and T_{E}_{_{B}}_{(0,0)} described hereinabove, by merging of these two tables, a transition table T_{E(0,0)} associated with the state E(0,0) is obtained such that:

$$\{ \begin{matrix}∀ v ∈ [ 0 … 56 ] ⋃ [ 58 … 255 ] {T}_{E ( 0 , 0 )} ( v ) = 0 \\ {T}_{E ( 0 , 0 )} ( 57 ) = E ( 1 , 0 ) = 〈 {E}_{A} ( 1 , 0 ) , {E}_{B} ( 1 , 0 ) 〉\end{matrix}$$

A new non-deterministic state E(1,0) is thus created by the merging of the two states E_{A}(1,0) and E_{B}(1,0), a process which is illustrated in FIG. 5C.

The process of joining of the graphs A and B continues by successively processing all the non-deterministic states created during the processing of the preceding depth level of the graph, and this continues until the last depth level of the graph is reached. In the case of the example described, after the state E(1,0)=<E_{A}(1,0),E_{B}(1,0)> has been created at the depth level 1, the following operations are executed:
the transition tables T_{E}_{_{A}}_{(1,0)} and T_{E}_{_{B}}_{(1,0)} are merged into one transition table T(1,0) associated with the state E(1,0) such that:

$$\{ \begin{matrix}∀ v ∈ [ 0 … 6 ] ⋃ [ 8 … 255 ] {T}_{E ( 1 , 0 )} ( v ) = 0 \\ {T}_{E ( 1 , 0 )} ( 7 ) = E ( 2 , 0 ) = 〈 {E}_{A} ( 2 , 0 ) , {E}_{B} ( 2 , 0 ) 〉\end{matrix}$$

the transition tables T_{E}_{_{A}}_{(2,0)} and T_{E}_{_{B}}_{(2,0)} are merged into one transition table T_{E(2,0)} associated with the new state E(2,0), shown in FIG. 5D, created by merging two states E_{A}(2,0) and E_{B}(2,0), such that:

$$\{ \begin{matrix}∀ v ∈ [ 0 … 1 ] ⋃ [ 3 … 255 ] {T}_{E ( 2 , 0 )} ( v ) = E ( 3 , 1 ) = {E}_{B} ( 3 , 0 ) \\ {T}_{E ( 2 , 0 )} ( 2 ) = E ( 3 , 0 ) = 〈 {E}_{A} ( 3 , 0 ) , {E}_{B} ( 3 , 0 ) 〉\end{matrix}$$

the state E_{B}(3,0) being denoted E(3,1) in the resulting graph, as shown in FIG. 5E. The state E(3,1) has the same transition table as the state E_{B}(3,0).

When the last depth level of a graph is processed, the process of merging two transition tables TA and TB into one transition table T is modified and depends on the semantic used.

In the case of a semantic of the “first match” type, this is carried out in the following manner:
if TA(v)≠0 then T(v)=TA(v)
otherwise T(v)=TB(v)
   In other words, the state associated with the first rule processed is favored, i.e. the transition table TA.

In the case of a semantic of the “last match” type, this is carried out in the following manner:
if TB(v)≠0 then T(v)=TB(v)
otherwise T(v)=TA(v)
   In other words, the state associated with the last rule processed is favored, i.e. the transition table TB.

By this process of merging of graphs and transition tables, the semantic defined for a list of rules is taken into account during the determination of a category to be assigned to a packet, without any additional processing or operation with respect to the simple execution of the graph and application of the transition tables.

In the case of the example described, it is assumed that a semantic of the “first match” type is used. After the state E(3,0)=<E_{A} (3,0),E_{B} (3,0)> has been created at the depth level 3, the transition tables T_{E}_{_{A}}_{(3,0)} and T_{E}_{_{B}}_{(3,0)} are therefore merged into one transition table T_{E(3,0)} associated with the state E(3,0) such that:

$$\{ \begin{matrix}∀ v ∈ [ 0 ] ⋃ [ 2 … 255 ] {T}_{E ( 3 , 0 )} ( v ) = E ( 4 , 1 ) = {E}_{B} ( 4 , 0 ) \\ {T}_{E ( 3 , 0 )} ( 1 ) = E ( 4 , 0 ) = {E}_{A} ( 4 , 0 )\end{matrix}$$

The final states E_{A}(4,0) and E_{B}(4,0) are accordingly conserved as final states E(4,0) and E(4,1) of the graph, shown in FIG. 5F, resulting from the merging of the graphs A and B, the final state E(4,0) being associated with the action ‘permit’ and the final state E(4,0) being associated with the action ‘deny’.

The graph shown in FIG. 5F may be used in order to classify a packet according to the two rules R_{A} and R_{B} defined hereinbelow, by using the classification process described with reference to FIG. 3.

The method according to the invention provides an efficient classification of the packets into various categories, notably a minimum and constant time, independently of the number of rules or of the packet. It enables the data packets to be processed byte by byte or with any given size of data block that may be appropriate with regard to the data processor or the data processing device used.

It is applicable to any list of rules defining classification criteria relating to the values of the data fields to be processed.

1. A method for classifying data packets according to an ordered list of at least one classification rule, comprising a step for determining, for each data packet to be processed, an associated category of packet, a said classification rule defining, on the one hand, a criterion relating to at least one data field present in the packets to be classified and, on the other, a category of packet intended to be associated with a packet whose said at least one data field contains a value matching said criterion,
wherein the category associated with a packet is identified by a classification value determined in a predetermined number NB of iterations starting from an initial classification value and as a function of NB data blocks of the packet to be processed,
the set of said NB data blocks comprising the field or fields of data used for the definition of the rules in said list, the size of said data blocks being chosen from amongst a set of several sizes of block,
an iteration comprising a step for determination of a current classification value starting from the classification value obtained in the preceding iteration and from the value contained in the i^{th} data block, the order in which said data blocks are considered being predetermined.

2. The method as claimed in claim 1 in which the current classification value is determined during said iteration by application, to the value of the i^{th} data block from the packet in question, of a predetermined association function, identified by the classification value obtained in the preceding iteration.

3. The method as claimed in claim 1, in which the category of packet assigned to a packet takes into account a semantic associated with said list.

4. The method as claimed in claim 1, in which, during the i^{th} iteration, where i is an integer such that 1≦i≦NB, a current classification value is determined by reading, in a table identified by the classification value obtained in the preceding iteration, the classification value associated with the value of the i^{th} data block from the packet in question.

5. The method as claimed in claim 1, in which the block size is chosen to be greater than or equal to 2 bits.

6. The method as claimed in claim 1, comprising a step for the generation, starting from said list, of a directed acyclic graph with NB depth levels, said graph being representative of a state automaton,
a said classification value identifying a state of said automaton, said initial classification value identifying the initial state of said automaton, the transition table for a state of level p−1 of the automaton, where p is an integer such that 1≦p≦NB, being a function between the set of the possible values of the p^{th} data block and the set of the state identifiers of level p.

7. The method as claimed in claim 6, comprising a step for construction of a list-degenerate graph with NB depth levels based on each of the rules in said list, said directed acyclic graph being obtained by the joining of the degenerate graphs constructed, a list-degenerate graph representing an automaton with (NB+1) states and NB transitions.

8. The method as claimed in claim 7 in which the joining of the degenerate graphs is carried out by taking into account a semantic associated with said list.

9. The method as claimed in claim 7, in which said joining is an iterative process, each iteration comprising a step for obtaining a current graph by the joining of a list-degenerate graph with the graph obtained in the preceding iteration and a step for minimization of said current graph.

10. The method as claimed in claim 7, comprising a step consisting in translating the criterion for each of the classification rules in said list into a list of NB sets of data block values, in such a manner that a data packet matches this criterion if and only if, for each integer p such that 1≦p≦NB, the value contained in the p^{th} data block of this packet is comprised within the p^{th} set of values, the p^{th} set of values comprising the value or values which a transition exists between the (p−1)^{th} state and the p^{th} state of the automaton represented by the list-degenerate graph obtained based on the rule in question.

11. (canceled)

12. A recording medium readable by a data processor on which is recorded a program comprising program code instructions for the execution of the steps of a method as claimed in claim 1.

13. A device for classifying data packets according to an ordered list of at least one classification rule, comprising means for determining, for each data packet to be processed, an associated category of packet, a said classification rule defining, on the one hand, a criterion relating to at least one data field present in the packets to be classified and, on the other, a category of packet intended to be associated with a packet whose said at least one data field contains a value matching said criterion,
wherein said means are designed to determine a classification value identifying the category associated with a packet in a predetermined number NB of iterations starting from an initial classification value and as a function of NB data blocks of the packet to be processed,
the set of said NB data blocks comprising the data field or data fields used for the definition of the rules in said list, the size of said data blocks being chosen from amongst a set of several sizes of block,
an iteration comprising a step for determining a current classification value starting from the classification value obtained in the preceding iteration and from the value contained in the i^{th} data block, the order in which said data blocks are considered being predetermined.

14. The device as claimed in claim 13, in which said means are designed to determine, during the i^{th} iteration, where i is an integer in the range between 1 and NB, a current classification value by reading, in a table identified by the classification value obtained in the preceding iteration, the classification value associated with the value of the i^{th} data block of the packet in question.

15. The device as claimed in claim 13, comprising means for implementing the steps of a method for classifying data packets according to an ordered list of at least one classification rule, comprising a step for determining, for each data packet to be processed, an associated category of packet,
a said classification rule defining, on the one hand, a criterion relating to at least one data field present in the packets to be classified and, on the other, a category of packet intended to be associated with a packet whose said at least one data field contains a value matching said criterion, wherein the category associated with a packet is identified by a classification value determined in a predetermined number NB of iterations starting from an initial classification value and as a function of NB data blocks of the packet to be processed,
the set of said NB data blocks comprising the field or fields of data used for the definition of the rules in said list, the size of said data blocks being chosen from amongst a set of several sizes of block,
an iteration comprising a step for determination of a current classification value starting from the classification value obtained in the preceding iteration and from the value contained in the i^{th} data block, the order in which said data blocks are considered being predetermined.

16. The device as claimed in claim 15, in which the block size is chosen to be greater than or equal to 2 bits.

17. The device as claimed in claim 15, the method further comprising a step for the generation, starting from said list, of a directed acyclic graph with NB depth levels, said graph being representative of a state automaton,
a said classification value identifying a state of said automaton, said initial classification value identifying the initial state of said automaton, the transition table for a state of level p−1 of the automaton, where p is an integer such that 1≦p≦NB, being a function between the set of the possible values of the p^{th} data block and the set of the state identifiers of level p.

18. The device as claimed in claim 14, comprising means for implementing the steps of a method for classifying data packets according to an ordered list of at least one classification rule, comprising a step for determining, for each data packet to be processed, an associated category of packet,
a said classification rule defining, on the one hand, a criterion relating to at least one data field present in the packets to be classified and, on the other, a category of packet intended to be associated with a packet whose said at least one data field contains a value matching said criterion, wherein the category associated with a packet is identified by a classification value determined in a predetermined number NB of iterations starting from an initial classification value and as a function of NB data blocks of the packet to be processed,
the set of said NB data blocks comprising the field or fields of data used for the definition of the rules in said list, the size of said data blocks being chosen from amongst a set of several sizes of block,
an iteration comprising a step for determination of a current classification value starting from the classification value obtained in the preceding iteration and from the value contained in the ith data block, the order in which said data blocks are considered being predetermined.

19. The device as claimed in claim 18, in which the block size is chosen to be greater than or equal to 2 bits.

20. The device as claimed in claim 18, the method further comprising a step for the generation, starting from said list, of a directed acyclic graph with NB depth levels, said graph being representative of a state automaton,
a said classification value identifying a state of said automaton, said initial classification value identifying the initial state of said automaton, the transition table for a state of level p−1 of the automaton, where p is an integer such that 1≦p≦NB, being a function between the set of the possible values of the p^{th} data block and the set of the state identifiers of level p.
